(19) United States
(12) Patent Application Publication
(10) Pub. No.: US 2015/0244939 A1
(43) Pub. Date: Aug. 27, 2015

(54) HANDHELD ELECTRONIC DEVICE AND METHOD FOR TAKING PHOTO BY HANDHELD ELECTRONIC DEVICE

(71) Applicant: Wistron Corporation, New Taipei City (TW)

(72) Inventors: Wen-Hsin Liao, New Taipei City (TW); Yu-Tzu Lin, New Taipei City (TW)

(21) Appl. No.: 14/485,809

(22) Filed: Sep. 15, 2014

(30) Foreign Application Priority Data
Feb. 24, 2014 (TW) 103106115

(51) Int. Cl. H04N 5/232; G01P 15/14; H04N 5/225; G01C 19/00

(52) U.S. Cl. CPC H04N 5/23258; G01C 19/00; G01P 15/14; H04N 5/2252; H04N 5/23245

(57) ABSTRACT

A handheld electronic device includes a casing; a camera unit disposed in the casing; a light sensing unit disposed in the casing; and a processing unit disposed in the casing and electrically connected to the camera unit and the light sensing unit, the processing unit determining whether the light sensing unit is covered continuously for a predetermined time period, the processing unit driving the camera unit to take a photo when the light sensing unit is covered continuously for the predetermined time period.

### BACKGROUND OF THE INVENTION

1. Field of the Invention

The invention relates to a handheld electronic device and a method for taking a photo by the handheld electronic device and, more particularly, to a handheld electronic device capable of avoiding taking a blurred photo and a method for taking a photo by the handheld electronic device.

2. Description of the Prior Art

As technology advances and develops, lots of handheld electronic devices (e.g. mobile phone, personal digital assistant, tablet computer, etc.) are equipped with a camera unit for taking photos. In general, a user may press a physical button on the handheld electronic device or a virtual button provided by a touch panel to drive the camera unit to take a photo. However, when the user presses the physical or virtual button, the handheld electronic device may be vibrated or shaken, such that the photo may be blurred due to out of focus, vibration or background shifting. Furthermore, other prior arts drive the camera unit to take a photo through voice control. However, the user has to open his/her mouth to make a voice command for driving the camera unit, a facial expression of the user may be unnatural.

### SUMMARY OF THE INVENTION

The invention provides a handheld electronic device capable of avoiding taking a blurred photo and a method for taking a photo by the handheld electronic device, so as to solve the aforesaid problems.

According to the claimed invention, a handheld electronic device comprises a casing, a camera unit, a light sensing unit and a processing unit. The camera unit is disposed in the casing. The light sensing unit is disposed in the casing. The processing unit is disposed in the casing and electrically connected to the camera unit and the light sensing unit. The processing unit determines whether the light sensing unit is covered continuously for a predetermined time period. The processing unit drives the camera unit to take a photo when the light sensing unit is covered continuously for the predetermined time period.

According to the claimed invention, the handheld electronic device further comprises a motion sensing unit disposed in the casing and electrically connected to the processing unit. The motion sensing unit senses a motion of the casing. The processing unit determines whether the motion of the casing is within plus and minus 1 degree per second. The processing unit drives the camera unit to take a photo when the light sensing unit is covered continuously for the predetermined time period and the motion of the casing is within plus and minus 1 degree per second.

According to the claimed invention, the motion sensing unit is a gyro, a g-sensor or a combination thereof.

According to the claimed invention, the handheld electronic device further comprises a display unit disposed in the casing and electrically connected to the processing unit. The display unit displays a setting interface. The setting interface is used to turn on or turn off a vibration reduction function. When the vibration reduction function is turned off, the processing unit determines whether to drive the camera unit to take a photo according to whether the light sensing unit is covered continuously for the predetermined time period. When the vibration reduction function is turned on, the processing unit determines whether to drive the camera unit to take a photo according to whether the light sensing unit is covered continuously for the predetermined time period and whether the motion of the casing is within plus and minus 1 degree per second.

According to the claimed invention, a method for taking a photo by a handheld electronic device is provided. The handheld electronic device comprises a camera unit, a light sensing unit and a processing unit. The processing unit is electrically connected to the camera unit and the light sensing unit. The method comprises steps of covering the light sensing unit; the processing unit determining whether the light sensing unit is covered continuously for a predetermined time period; and the processing unit driving the camera unit to take a photo when the light sensing unit is covered continuously for the predetermined time period.

According to the claimed invention, the handheld electronic device further comprises a casing and a motion sensing unit. The camera unit, the light sensing unit, the processing unit and the motion sensing unit are disposed in the casing. The motion sensing unit is electrically connected to the processing unit. The method further comprises steps of the motion sensing unit sensing a motion of the casing; the processing unit determining whether the motion of the casing is within plus and minus 1 degree per second; and the processing unit driving the camera unit to take a photo when the light sensing unit is covered continuously for the predetermined time period and the motion of the casing is within plus and minus 1 degree per second.

According to the claimed invention, the motion sensing unit is a gyro, a g-sensor or a combination thereof.

According to the claimed invention, the handheld electronic device further comprises a display unit disposed in the casing and electrically connected to the processing unit. The method further comprises steps of the display unit displaying a setting interface, wherein the setting interface is used to turn on or turn off a vibration reduction function; when the vibration reduction function is turned off, the processing unit determining whether to drive the camera unit to take a photo according to whether the light sensing unit is covered continuously for the predetermined time period; and when the vibration reduction function is turned on, the processing unit determining whether to drive the camera unit to take a photo according to whether the light sensing unit is covered continuously for the predetermined time period and whether the motion of the casing is within plus and minus 1 degree per second.

As mentioned in the above, when the vibration reduction function is turned off, the invention may determine whether to drive the camera unit to take a photo according to whether the light sensing unit is covered continuously for the predetermined time period (e.g. 1 second, 3 seconds, etc.). When a user wants to use the handheld electronic device of the invention to take a photo, the user may cover the light sensing unit by a finger. At this time, the processing unit determines that the light sensing unit has been covered. When the light sensing unit is covered continuously for the predetermined time period, the processing unit drives the camera unit to take a photo accordingly. Since the user only has to cover the light sensing unit by the finger without any press motion, the invention can avoid vibrating or shaking the handheld electronic device, so as to avoid taking a blurred photo due to out of focus, vibration or background shifting. Furthermore, when the vibration reduction function is turned on, the invention may determine whether to drive the camera unit to take a photo according to whether the light sensing unit is covered continuously for the predetermined time period and whether the motion of the casing is within plus and minus 1 degree per second. In other words, when the light sensing unit is covered continuously for the predetermined time period and the motion of the casing is within plus and minus 1 degree per second, the processing unit drives the camera unit to take a photo accordingly. On the other hand, when the light sensing unit is covered continuously for the predetermined time period but the motion of the casing is beyond plus and minus 1 degree per second, the processing unit will not drive the camera unit to take a photo. Therefore, the invention can further avoid taking a blurred photo if the user does not hold the handheld electronic device stably.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a handheld electronic device according to an embodiment of the invention.

FIG. 2 is a functional block diagram illustrating the handheld electronic device shown in FIG. 1.

FIG. 3 is a schematic diagram illustrating the light sensing unit shown in FIG. 1 covered by a finger of a user.

FIG. 4 is a schematic diagram illustrating a setting interface displayed by the display unit shown in FIG. 1.

FIG. 5 is a flowchart illustrating a method for taking a photo by the handheld electronic device according to an embodiment of the invention.

FIG. 6 is a flowchart illustrating a method for taking a photo by the handheld electronic device according to another embodiment of the invention.

### DETAILED DESCRIPTION

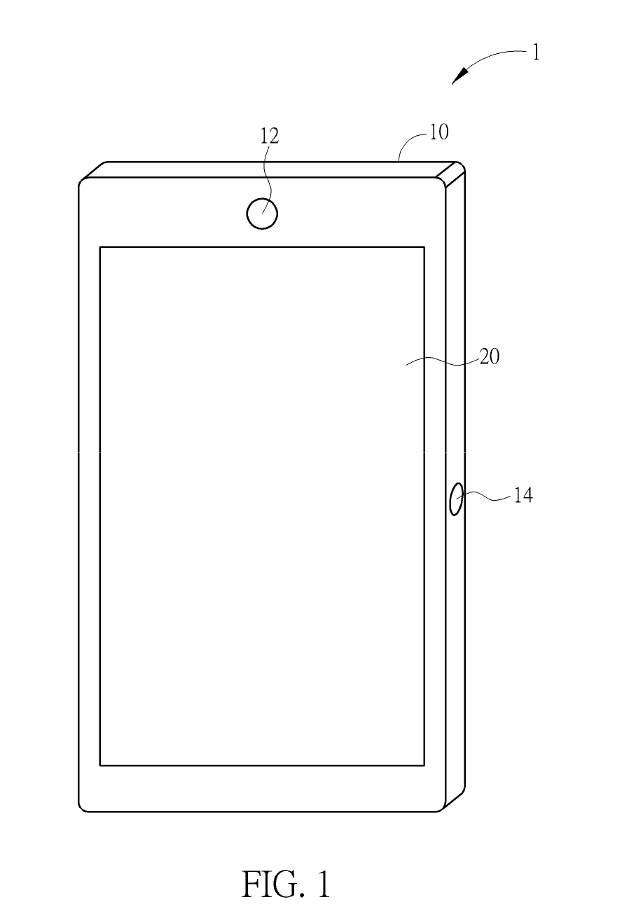

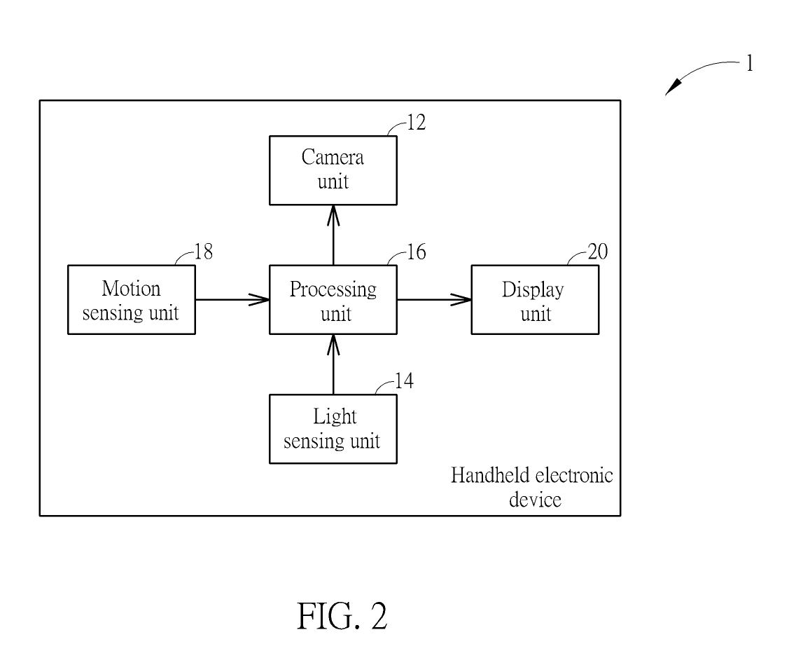

Referring to FIGS. 1 and 2, FIG. 1 is a schematic diagram illustrating a handheld electronic device 1 according to an embodiment of the invention, and FIG. 2 is a functional block diagram illustrating the handheld electronic device 1 shown in FIG. 1. As shown in FIGS. 1 and 2, the handheld electronic device 1 comprises a casing 10, a camera unit 12, a light sensing unit 14, a processing unit 16, a motion sensing unit 18 and a display unit 20, wherein the camera unit 12, the light sensing unit 14, the processing unit 16, the motion sensing unit 18 and the display unit 20 are disposed in the casing 10, and the processing unit 16 is electrically connected to the camera unit 12, the light sensing unit 14, the motion sensing unit 18 and the display unit 20.

In practical applications, the handheld electronic device 1 may be an electronic device with data processing and photo taking functions, such as a mobile phone, a personal digital assistant, a tablet computer, etc.; the camera unit 12 may be a camera module including a charge-coupled device (CCD) sensor or a complementary metal-oxide semiconductor (CMOS) sensor; the light sensing unit 14 may be a light sensor for sensing an environmental light; the processing unit 16 may be a processor or controller with data calculating/processing function; the motion sensing unit 18 may be a gyro, a g-sensor or a combination thereof; and the display unit 20 may be a liquid crystal display device or other display devices. In general, the handheld electronic device 1 may be further equipped with some necessary hardware or software components for specific purposes, such as a memory, a power supply, an operating system, applications, a communication module, an input/output module, etc., and it depends on practical applications.

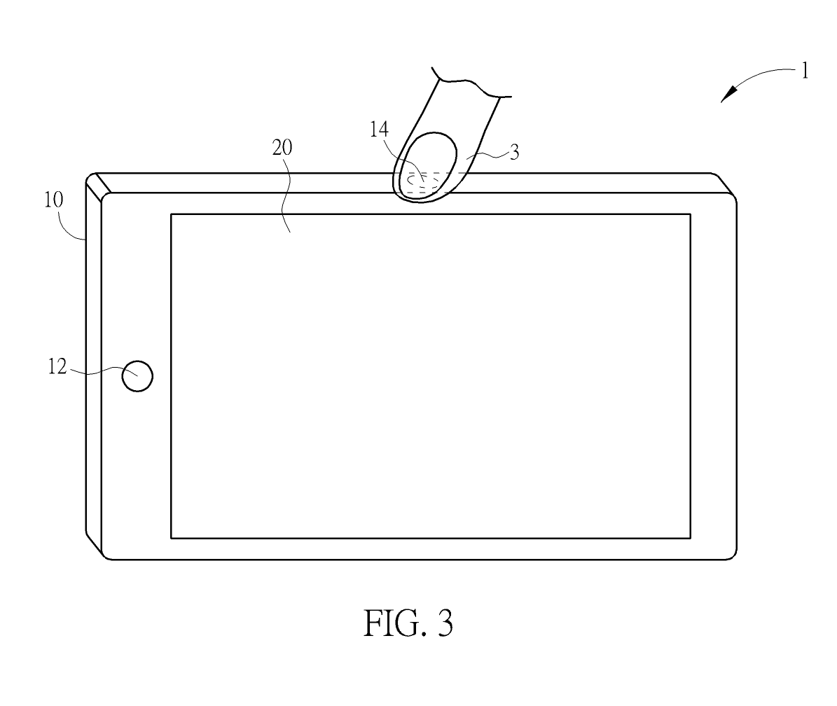

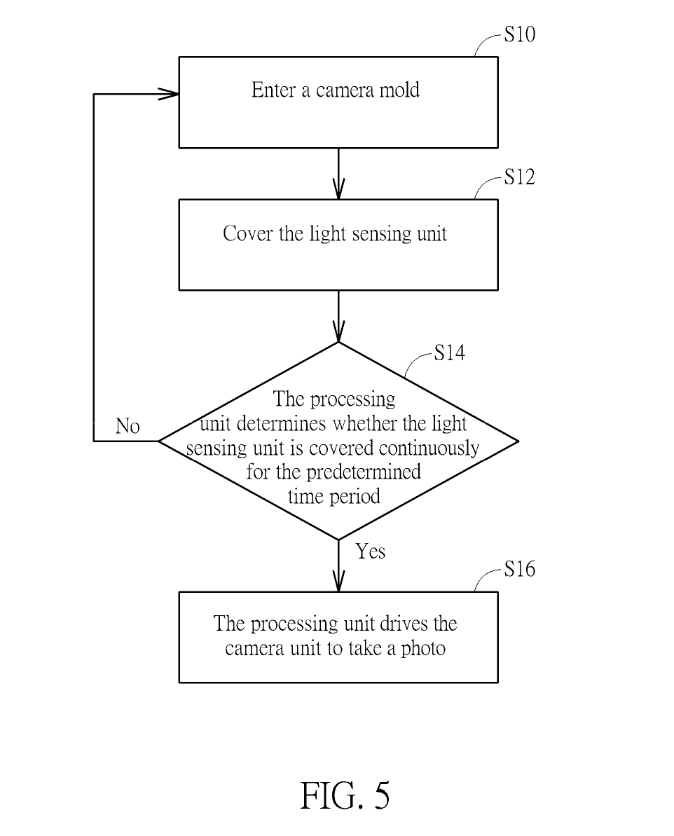

Referring to FIG. 3, FIG. 3 is a schematic diagram illustrating the light sensing unit 14 shown in FIG. 1 covered by a finger 3 of a user. As shown in FIGS. 3 and 5, when a user operates the handheld electronic device 1 to turn on the camera unit 12, the user can use the finger 3 to cover the light sensing unit 14, so as to drive the camera unit 12 to take a photo. When the light sensing unit 14 is covered, the light sensing unit 14 will not sense the environmental light or will only sense the environmental light lower than a threshold. At this time, the processing unit 16 determines that the light sensing unit 14 has been covered. Afterwards, the processing unit 16 determines whether the light sensing unit 14 is covered continuously for a predetermined time period (e.g. 1 second, 3 seconds, etc.). When the processing unit 16 determines that the light sensing unit 14 is covered continuously for the predetermined time period, the processing unit 16 drives the camera unit 12 to take a photo accordingly. On the other hand, when the processing unit 16 determines that the light sensing unit 14 is not covered continuously for the predetermined time period, the processing unit 16 does not drive the camera unit 12 to take a photo accordingly. Since the user only has to cover the light sensing unit 14 by the finger 3 without any press motion, the invention can avoid vibrating or shaking the handheld electronic device 1, so as to avoid taking a blurred photo due to out of focus, vibration or background shifting. In this embodiment, the light sensing unit 14 is disposed at one edge of the casing 10, such that the user can cover the light sensing unit 14 to take a photo conveniently. In another embodiment, the light sensing unit 14 may be disposed at any position of the casing 10 based on practical applications.

It should be noted that the aforesaid predetermined time period may a system default value or be set by the user based on his/her preference. Furthermore, when the handheld electronic device 1 is located in an environment with slight light, the light emitted by the display unit 20 may be taken to be the aforesaid environmental light.

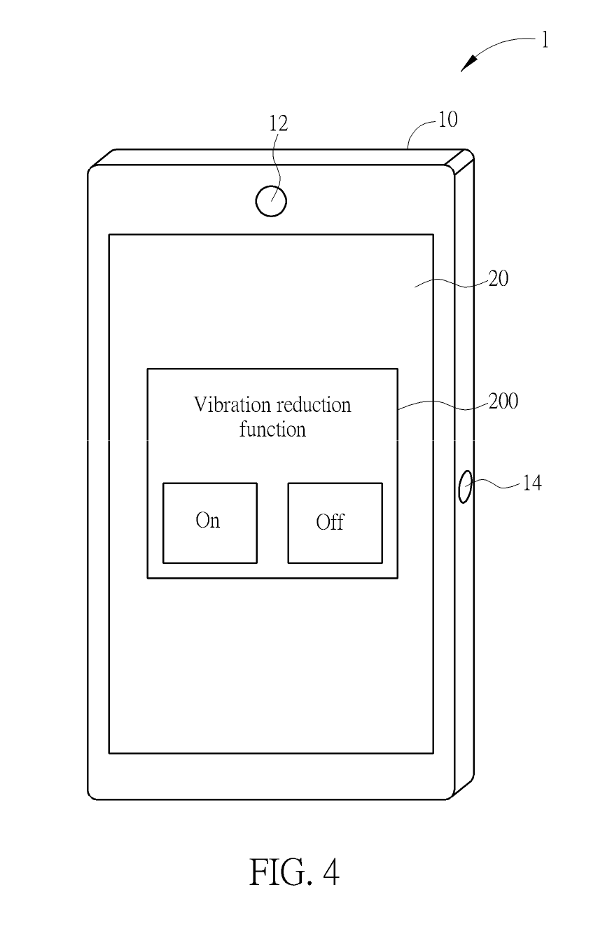

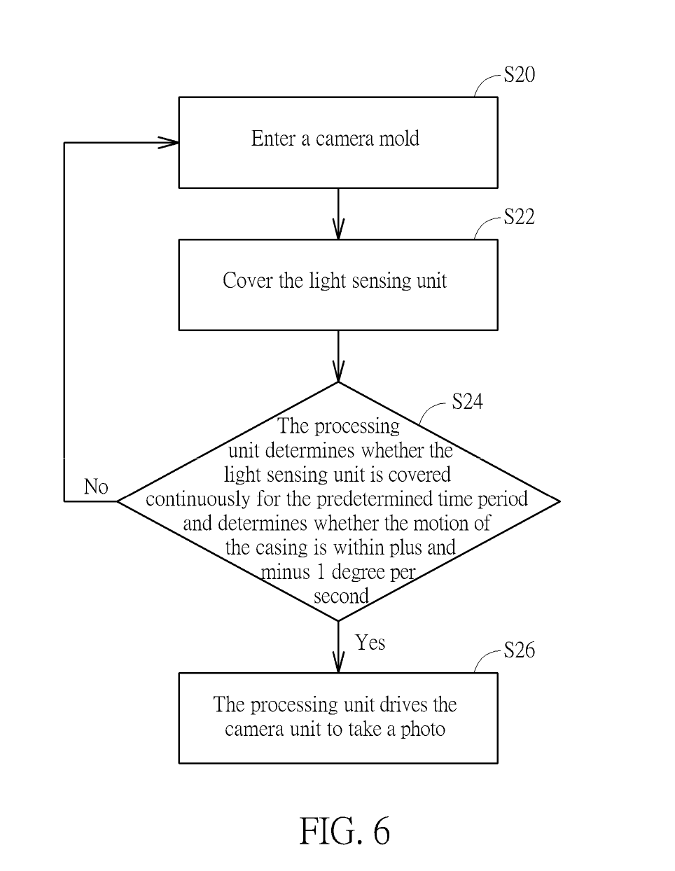

Referring to FIG. 4, FIG. 4 is a schematic diagram illustrating a setting interface 200 displayed by the display unit 20 shown in FIG. 1. As shown in FIG. 4, the display unit 20 may display a setting interface 200, wherein the setting interface 200 is used to turn on or turn off a vibration reduction function. Furthermore, the motion sensing unit 18 can sense a motion of the casing 10. When the user turns on the vibration reduction function in the setting interface 200 for taking a photo, the processing unit 16 will further determine whether the motion of the casing 10 is within plus and minus 1 degree per second for X, Y and Z axes of a three-dimensional coordinate system (as shown in FIG. 6) in addition to the determination of whether the light sensing unit 14 is covered continuously for the predetermined time period. When the processing unit 16 determines that the light sensing unit 14 is covered continuously for the predetermined time period and the motion of the casing 10 is within plus and minus 1 degree per second for X, Y and Z axes of the three-dimensional coordinate system, the processing unit 16 drives the camera unit 12 to take a photo accordingly. On the other hand, when the processing unit 16 determines that the light sensing unit 14 is covered but the motion of the casing 10 is beyond plus and minus 1 degree per second for X, Y and Z axes of the three-dimensional coordinate system, the processing unit 16 will not drive the camera unit 12 to take a photo. Therefore, the invention can further avoid taking a blurred photo if the user does not hold the handheld electronic device 1 stably.

In other words, when the vibration reduction function is turned off, the processing unit 16 determines whether to drive the camera unit 12 to take a photo according to whether the light sensing unit 14 is covered continuously for the predetermined time period mainly; and when the vibration reduction function is turned on, the processing unit 16 determines whether to drive the camera unit 12 to take a photo according to whether the light sensing unit 14 is covered continuously for the predetermined time period and whether the motion of the casing 10 is within plus and minus 1 degree per second mainly.

Referring to FIG. 5, FIG. 5 is a flowchart illustrating a method for taking a photo by the handheld electronic device according to an embodiment of the invention. The method for taking a photo shown in FIG. 5 may be implemented by the aforesaid handheld electronic device 1. When the user turns off the vibration reduction function to take a photo, first of all, step S10 is performed to enter a camera mold. Afterwards, in step S12, the user covers the light sensing unit 14. Then, in step S14, the processing unit 16 determines whether the light sensing unit 14 is covered continuously for the predetermined time period. When the light sensing unit 14 is covered continuously for the predetermined time period, in step S16, the processing unit 16 drives the camera unit 12 to take a photo. When the light sensing unit 14 is not covered continuously for the predetermined time period, go back to step S10. It should be noted that the other operation principles of the method for taking a photo by the handheld electronic device of the invention are mentioned in the above and those will not be depicted herein again.

Referring to FIG. 6, FIG. 6 is a flowchart illustrating a method for taking a photo by the handheld electronic device according to another embodiment of the invention. The method for taking a photo shown in FIG. 6 may be implemented by the aforesaid handheld electronic device 1. When the user turns on the vibration reduction function to take a photo, first of all, step S20 is performed to enter a camera mold. Afterwards, in step S22, the user covers the light sensing unit 14. Then, in step S24, the processing unit 16 determines whether the light sensing unit 14 is covered continuously for the predetermined time period and determines whether the motion of the casing 10 is within plus and minus 1 degree per second. When the light sensing unit 14 is covered continuously for the predetermined time period and the motion of the casing 10 is within plus and minus 1 degree per second, in step S26, the processing unit 16 drives the camera unit 12 to take a photo. When the light sensing unit 14 is not covered continuously for the predetermined time period or the motion of the casing 10 is beyond plus and minus 1 degree per second, go back to step S20. It should be noted that the other operation principles of the method for taking a photo by the handheld electronic device of the invention are mentioned in the above and those will not be depicted herein again.

Furthermore, the control logic of the method for taking a photo by the handheld electronic device shown in FIGS. 5 and 6 can be implemented by software. The software can be executed in any handheld electronic devices with data processing function, such as a mobile phone, a personal digital assistant, a tablet computer, etc. Needless to say, each part or function of the control logic may be implemented by software, hardware or the combination thereof.

As mentioned in the above, when the vibration reduction function is turned off, the invention may determine whether to drive the camera unit to take a photo according to whether the light sensing unit is covered continuously for the predetermined time period (e.g. 1 second, 3 seconds, etc.). When a user wants to use the handheld electronic device of the invention to take a photo, the user may cover the light sensing unit by a finger. At this time, the processing unit determines that the light sensing unit has been covered. When the light sensing unit is covered continuously for the predetermined time period, the processing unit drives the camera unit to take a photo accordingly. Since the user only has to cover the light sensing unit by the finger without any press motion, the invention can avoid vibrating or shaking the handheld electronic device, so as to avoid taking a blurred photo due to out of focus, vibration or background shifting. Furthermore, when the vibration reduction function is turned on, the invention may determine whether to drive the camera unit to take a photo according to whether the light sensing unit is covered continuously for the predetermined time period and whether the motion of the casing is within plus and minus 1 degree per second. In other words, when the light sensing unit is covered continuously for the predetermined time period and the motion of the casing is within plus and minus 1 degree per second, the processing unit drives the camera unit to take a photo accordingly. On the other hand, when the light sensing unit is covered continuously for the predetermined time period but the motion of the casing is beyond plus and minus 1 degree per second, the processing unit will not drive the camera unit to take a photo. Therefore, the invention can further avoid taking a blurred photo if the user does not hold the handheld electronic device stably.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A handheld electronic device comprising:
a casing;
a camera unit disposed in the casing;
a light sensing unit disposed in the casing; and
a processing unit disposed in the casing and electrically connected to the camera unit and the light sensing unit, the processing unit determining whether the light sensing unit is covered continuously for a predetermined time period, the processing unit driving the camera unit to take a photo when the light sensing unit is covered continuously for the predetermined time period.

2. The handheld electronic device of claim 1, further comprising a motion sensing unit disposed in the casing and electrically connected to the processing unit, the motion sensing unit sensing a motion of the casing, the processing unit determining whether the motion of the casing is within plus and minus 1 degree per second, the processing unit driving the camera unit to take a photo when the light sensing unit is covered continuously for the predetermined time period and the motion of the casing is within plus and minus 1 degree per second.

3. The handheld electronic device of claim 2, wherein the motion sensing unit is a gyro, a g-sensor or a combination thereof.

4. The handheld electronic device of claim 2, further comprising a display unit disposed in the casing and electrically connected to the processing unit, the display unit displaying a setting interface, the setting interface being used to turn on or turn off a vibration reduction function; when the vibration reduction function is turned off, the processing unit determining whether to drive the camera unit to take a photo according to whether the light sensing unit is covered continuously for the predetermined time period; when the vibration reduction function is turned on, the processing unit determining whether to drive the camera unit to take a photo according to whether the light sensing unit is covered continuously for the predetermined time period and whether the motion of the casing is within plus and minus 1 degree per second.

5. A method for taking a photo by a handheld electronic device, the handheld electronic device comprising a camera unit, a light sensing unit and a processing unit, the processing unit being electrically connected to the camera unit and the light sensing unit, the method comprising:
covering the light sensing unit;
the processing unit determining whether the light sensing unit is covered continuously for a predetermined time period; and
the processing unit driving the camera unit to take a photo when the light sensing unit is covered continuously for the predetermined time period.

6. The method of claim 5, wherein the handheld electronic device further comprises a casing and a motion sensing unit, the camera unit, the light sensing unit, the processing unit and the motion sensing unit are disposed in the casing, the motion sensing unit is electrically connected to the processing unit, the method further comprises:
the motion sensing unit sensing a motion of the casing;
the processing unit determining whether the motion of the casing is within plus and minus 1 degree per second; and
the processing unit driving the camera unit to take a photo when the light sensing unit is covered continuously for the predetermined time period and the motion of the casing is within plus and minus 1 degree per second.

7. The method of claim 6, wherein the motion sensing unit is a gyro, a g-sensor or a combination thereof.

8. The method of claim 6, wherein the handheld electronic device further comprises a display unit disposed in the casing and electrically connected to the processing unit, the method further comprises:
the display unit displaying a setting interface, wherein the setting interface is used to turn on or turn off a vibration reduction function;
when the vibration reduction function is turned off, the processing unit determining whether to drive the camera unit to take a photo according to whether the light sensing unit is covered continuously for the predetermined time period; and
when the vibration reduction function is turned on, the processing unit determining whether to drive the camera unit to take a photo according to whether the light sensing unit is covered continuously for the predetermined time period and whether the motion of the casing is within plus and minus 1 degree per second.
